(19) United States
(12) Patent Application Publication
(10) Pub. No.: US 2010/0126612 A1
(43) Pub. Date: May 27, 2010

(54) WATER FLOW TEMPERATURE CONTROL SYSTEM

(75) Inventors: Chung-Yi HUANG, Taichung County (TW); Ming-Chia WU, Taichung County (TW); Tsung-Yi LO, Taichung County (TW); Chung-Hsiang CHANG, Taichung County (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: GLOBE UNION INDUSTRIAL CORP., Taichung County (TW)

(21) Appl. No.: 12/277,322

(22) Filed: Nov. 25, 2008

(51) Int. Cl. F16K 11/00

(52) U.S. Cl. 137/625.41

(57) ABSTRACT

A water flow temperature control system is described. A hot and cold water flow respectively flow through a first and a second inlet passage of a valve and reach a temperature control sheet through a pressure equalization valve and two water seals. The quantities of the water flows are controlled by changing positions of two large or two small tapered adjusting holes on the temperature control sheet relative to the two water seals before flowing towards a water mixer of a mixing device. The water flows enter from a large opening portion of the water mixer, and are mixed in a helical direction. After that, the water flows pass through a number of outlet holes on a small opening portion of the water mixer towards an outlet passage of the valve. The center of the temperature control sheet is connected to a first end of a transmission shaft.

### BACKGROUND OF THE INVENTION

1. Field of Invention

The present invention relates to a water flow temperature control system, and more particularly to a water flow temperature control system having a two-stage control of dual flows and achieving an optimized stable mixing effect within a short distance.

2. Related Art

Currently, a common mixed water tap is generally limited to a design of a device for mixing cold and hot water, and is unable to actively adjust the water pressure in case of an abnormal change (for example, water is drawn from a single water tap or from multiple water taps at the same time), such that the outlet water is easily subjected to a sudden temperature drop or rise. Especially in winter, if the hot water pressure is suddenly lowered, the flow quantity thereof is reduced sharply, and thus the temperature of the water flowing out of the tap drops accordingly. In this case, the user may easily catch a cold if continuing using the device. On the contrary, if the cold water pressure is suddenly increased, the temperature of the outlet water rises abruptly, and the user may be easily scalded.

Further, in order to simultaneously control the temperature of the outlet water, the quantities of the inlet water (the hot water and the cold water) must be controlled in advance. U.S. Pat. No. 6,880,575 has disclosed a water mixing valve including two water inlets, a mixing chamber, a rotatable control member having openings for controlling flows from the two water inlets to the mixing chamber, and a support. The control member includes a circular plate having a first surface and a second surface. The two water inlets seal against the first surface and the openings extend between the first surface and the second surface. The support is used for supporting the control member on the second surface. The support includes surfaces adjacent to the openings of the control member for directing water flows from the corresponding openings towards one another and into the mixing chamber for efficient mixing.

The openings of the control member are two correspondingly disposed tapered holes for controlling a large and a small water flow respectively passing through the two inlet holes. In particular, the tapered holes may be sawtooth-shaped to precisely control the water flow quantities. Moreover, a mixing feature having a plurality of blades for efficient mixing is disposed between the control member and the support.

As described above, the tapered holes for controlling the water flows are sawtooth-shaped so as to precisely control the flow quantities. However, under the circumstance that two modes of water discharging respectively from multiple water taps and from a single tap must be satisfied, if the control member is designed for a small flow and operates in a water-saving manner with merely one set of openings of the same size as water passages, an insufficient outlet water pressure is resulted when the control member switches to the mode of discharging water from multiple water taps even if the water is sufficiently mixed. Moreover, as the mixing feature is cylindrical, the water flow mixing path seems very long. However, the overall structure must be enlarged and elongated to achieve an efficient mixing effect even if the blades are added to generate a turbulent flow to enhance the mixing efficiency.

### SUMMARY OF THE INVENTION

Accordingly, the present invention is directed to a water flow temperature control system having a two-stage control of a large water quantity and a water-saving quantity simultaneously on the same temperature control sheet.

The present invention is also directed to a water flow temperature control system having a mixing device characterized in achieving an optimized stable mixed water flow temperature within a short distance.

Therefore, a water flow temperature control system including a valve, a pressure equalization valve, and a mixing device is provided. The valve has a first inlet passage, a second inlet passage, an outlet passage, and an upper cover. The pressure equalization valve is disposed in the valve for controlling the quantity of a water flow flowing through the first inlet passage and the quantity of a water flow flowing through the second inlet passage. The pressure equalization valve has a first chamber and a second chamber respectively disposed corresponding to the first inlet passage and the second inlet passage. The mixing device has a temperature control sheet, a first water seal, a second water seal, a transmission shaft, and a water mixer. The first water seal and the second water seal are pressed between the pressure equalization valve and the temperature control sheet and are disposed corresponding to the first chamber and the second chamber. The temperature control sheet has a number of adjusting holes disposed corresponding to the positions of the first water seal and the second water seal. The water mixer of a tapered funnel structure is rotatably disposed between the upper cover and the temperature control sheet and has a large opening portion and a small opening portion. The large opening portion is adjacent to the temperature control sheet. The small opening portion having a through-hole in the center and a number of water outlets is adjacent to the upper cover. The water mixer is connected to the upper cover by a hollow cylinder to form an integral structure. The through-hole of the water mixer is communicated with the hollow cylinder. A first end of the transmission shaft is connected to the temperature control sheet, and a second end of the transmission shaft is connected to a stepping motor through the through-hole, the hollow cylinder, and the upper cover, so as to control the rotation of the temperature control sheet through the stepping motor.

Preferably, the adjusting holes of the temperature control sheet include a first large tapered hole, a second large tapered hole, a first small tapered hole, and a second small tapered hole. Each tapered hole has a large area portion and a small area portion. The small area portion of the first large tapered hole is adjacent to the small area portion of the first small tapered hole. The large area portion of the first large tapered hole is adjacent to the small area portion of the second small tapered hole. The small area portion of the second large tapered hole is adjacent to the large area portion of the first small tapered hole. The large area portion of the second large tapered hole is adjacent to the large area portion of the second small tapered hole.

Preferably, the water mixer is further provided with a helical guide rib. The guide rib has an inlet portion and an outlet portion. The inlet portion is adjacent to the large opening portion. The outlet portion is adjacent to the small opening portion and connected to the water outlets.

Preferably, the water mixer is rotatably connected to the hollow cylinder.

A water flow temperature control system including a valve, a pressure equalization valve, a mixing device, a driving source, and a microcomputer control module is also provided. The valve has a first inlet passage, a second inlet passage, and an outlet passage. The pressure equalization valve is disposed in the valve and has a first chamber and a second chamber respectively disposed corresponding to the first inlet passage and the second inlet passage. The mixing device is disposed between the two inlet passages and the outlet passage of the valve and has a water mixer and a temperature control sheet. The temperature control sheet has a pair of penetrating large adjusting holes and a pair of penetrating small adjusting holes respectively. A cross-sectional area of the pair of large adjusting holes is larger than that of the pair of small adjusting holes. The driving source is used for driving the mixing sheet to move rotatably. The microcomputer control module controls the driving source to adjust a moving position of the temperature control sheet and selectively communicate the pair of first adjusting holes or the pair of second adjusting holes with the two inlet passages and the outlet passage.

Therefore, the water flow temperature control system provided by the present invention may realize a two-stage control on the same temperature control sheet, and achieve an optimized water flow mixing effect within a short distance by adopting the water mixer of a tapered funnel structure in the mixing device, so as to stably control the outlet water temperature to meet the demands of the user.

The detailed features and advantages of the present invention will be described in detail in the following embodiments. Those skilled in the arts can easily understand and implement the content of the present invention. Furthermore, the relative objectives and advantages of the present invention are apparent to those skilled in the arts with reference to the content disclosed in the specification, claims, and drawings.

### BRIEF DESCRIPTION OF THE DRAWINGS

The present invention will become more fully understood from the detailed description given herein below for illustration only, and thus are not limitative of the present invention, and wherein:

FIG. 1 is an exploded structural view of an embodiment of the present invention;

FIG. 2 is an assembled cross-sectional view of the embodiment of the present invention;

FIG. 3A is a schematic structural view of a pressure equalization valve according to the embodiment of the present invention when a hot water flow is larger than a cold water flow;

FIG. 3B is a schematic structural view of the pressure equalization valve according to the embodiment of the present invention when the hot water flow is smaller than the cold water flow;

FIG. 4 is a schematic structural view of a temperature control sheet according to the embodiment of the present invention;

FIG. 5 is a schematic structural view of a water mixer according to the embodiment of the present invention; and

FIG. 6 is a schematic structural view of a temperature control sheet according to another embodiment of the present invention.

### DETAILED DESCRIPTION OF THE INVENTION

Preferred embodiments of the present invention are illustrated in detail below with the accompanying drawings.

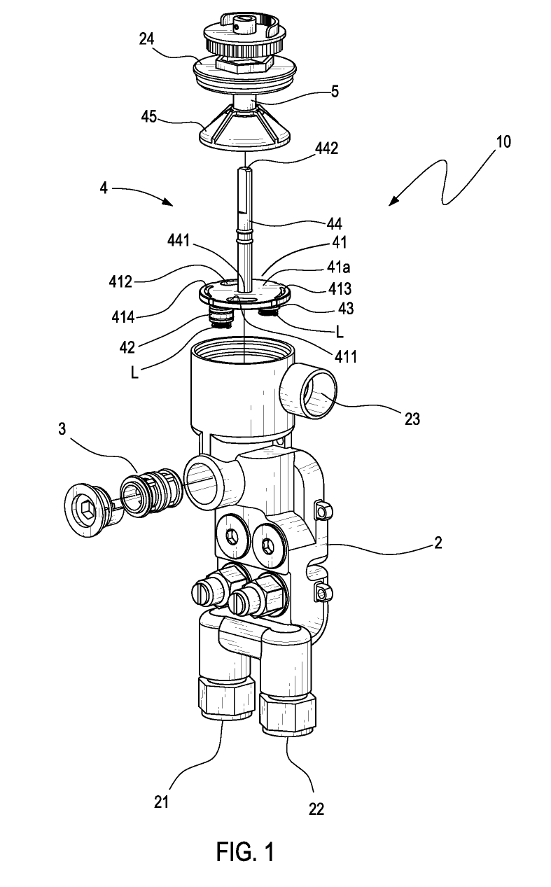

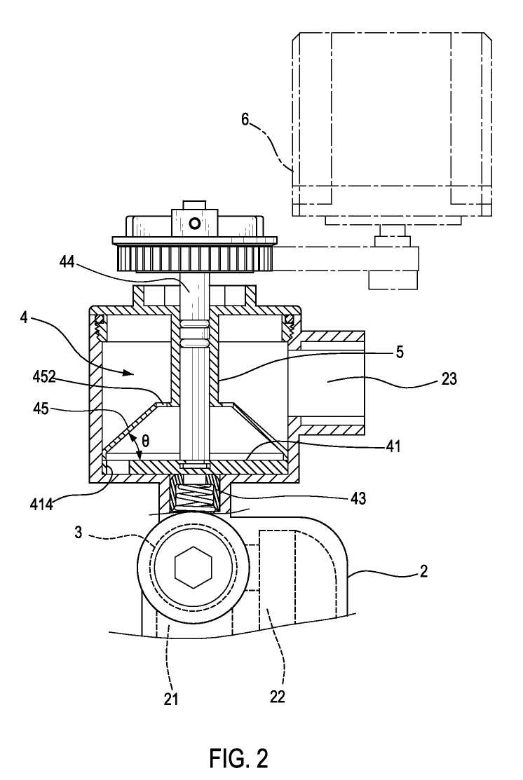

FIGS. 1 and 2 are respectively an exploded structural view and an assembled cross-sectional view of an embodiment of the present invention. A water flow temperature control system 1 of this embodiment includes a valve 2, a pressure equalization valve 3, and a mixing device 4.

The valve 2 has a first inlet passage 21 and a second inlet passage 22 at a lower side for being respectively connected to a hot water supply pipe and a cold water supply pipe (not shown). That is, the hot water flows through the first inlet passage 21 and the cold water flows through the second inlet passage 22. The valve 2 further has an outlet passage 23 at an upper side for the warm water after mixing in the mixing device 4 to flow out of a single water tap or multiple water taps (not shown).

An upper cover 24 is disposed on the top of the valve 2 for sealing the valve 2 to prevent the overflow of the warm water after mixing.

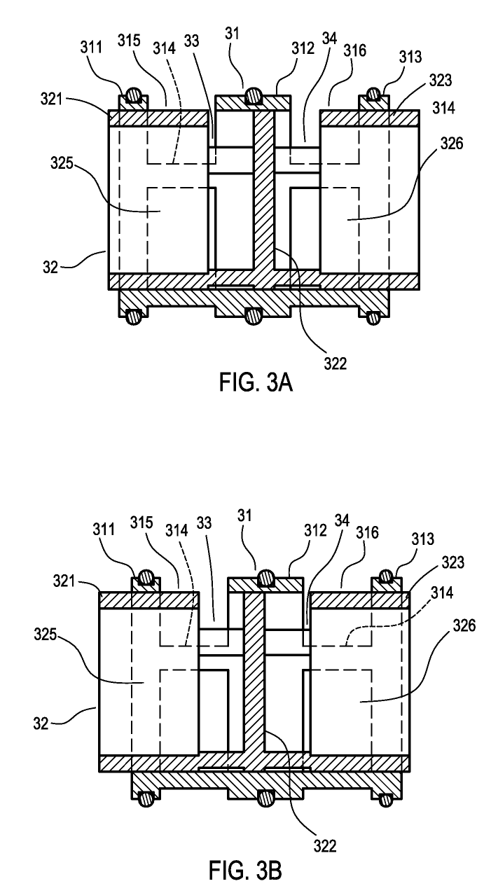

FIGS. 3A and 3B are respectively schematic structural views of the pressure equalization valve according to the embodiment of the present invention when the hot water flow is larger than the cold water flow and when the hot water flow is smaller than the cold water flow. The pressure equalization valve 3 controls the warm water flow through the first inlet passage 21 and the cold water flow through the second inlet passage 22, so as to provide warm water and cold water flows of different proportions to simultaneously flow into the mixing device 4 for mixing.

The pressure equalization valve 3 has a fixed member 31, a movable member 32, a first chamber 33, and a second chamber 34. The fixed member 31 having a hollow structure is fixed in the valve 2, and constituted by a first annular wall 311, a second annular wall 312, a third annular wall 313, and a number of connecting pillars 314. The second annular wall 312 is disposed between the first annular wall 311 and the third annular wall 313, and the annular walls are connected to each other through the connecting pillars 314. Therefore, a first inlet hole 315 and a second inlet hole 316 are respectively formed between the first annular wall 311 and the second annular wall 312 and between the second annular wall 312 and the third annular wall 313, i.e., at positions adjacent to and corresponding to the two inlet passages 21 and 22.

The movable member 32 is movably and axially pivoted in the fixed member 31, that is, the movable member 32 is capable of moving axially in the fixed member 31. The movable member 32 is provided with a first baffle plate 321, a second baffle plate 322, a third baffle plate 323, and a number of connecting pillars 324 at positions corresponding to the first annular wall 311, the second annular wall 312, and the third annular wall 313 of the fixed member 31. The connecting pillars 324 are disposed between the baffle plates for connecting these plates. Therefore, a first space 325 and a second space 326 are respectively formed at positions corresponding to the first inlet hole 315 and the second inlet hole 316.

The first inlet hole 315 and the first space 315 form the first chamber 33, and the second inlet hole 316 and the second space 326 form the second chamber 34.

Therefore, when the hot water flow (water pressure) is larger than the cold water flow, the hot water pressure is applied on the second baffle plate 322 to push the movable member 32 towards the third baffle plate 323. The first chamber 33 that the hot water flow passes through becomes smaller under the effect of the first baffle plate 321 and the second annular wall 312 (as shown in FIG. 3A), such that the quantity of the hot water flowing towards the mixing device 4 is reduced. Meanwhile, as the movable member 32 moves towards the third baffle plate 323, the second chamber 34 that the cold water flow passes through becomes larger, such that the quantity of the cold water flowing towards the mixing device 4 is increased. On the contrary, when the hot water flow (water pressure) is smaller than the cold water flow, the cold water pressure is applied on the second baffle plate 322 to push the movable member 32 towards the first baffle plate 321. The second chamber 34 that the cold water flow passes through becomes smaller under the effect of the third baffle plate 323 and the second annular wall 312 (as shown in FIG. 3B), such that the quantity of the cold water flowing towards the mixing device 4 is reduced. Meanwhile, as the movable member 32 moves towards the first baffle plate 321, the first chamber 33 that the hot water flow passes through becomes larger, such that the quantity of the hot water flowing towards the mixing device 4 is increased, so as to achieve the efficacy of pressure equalization.

Moreover, when the cold water flow loses pressure, i.e., the water pressure of the hot water flow is too large, the first chamber 33 is closed to stop the hot water flow, so as to prevent the hot water flow getting excessively large and protect the user from being scalded.

Again referring to FIGS. 1 and 2 together, the mixing device 4 of this embodiment includes a temperature control sheet 41, a first water seal 42, a second water seal 43, a transmission shaft 44, and a water mixer 45.

The first water seal 42 and the second water seal 43 are disposed between the temperature control sheet 41 and the pressure equalization valve 3, and respectively pressed against the first inlet hole 315 and the second inlet hole 316. Each water seal has a spring L installed therein, such that a buffer space exists between the pressure equalization valve 3 and the temperature control sheet 41.

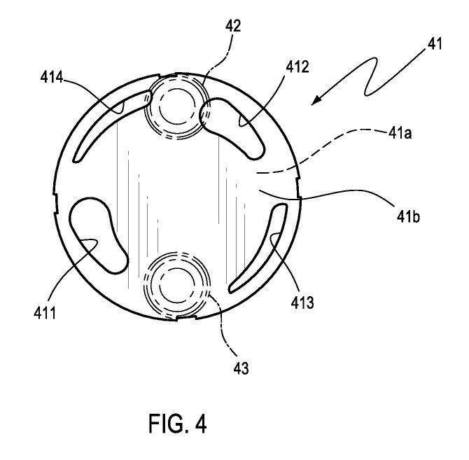

FIG. 4 is a schematic structural view of the temperature control sheet according to the embodiment of the present invention. The temperature control sheet 41 has a first surface 41a and a second surface 41b. The first surface 41a is pressed against the two water seals 42 and 43, and a central position of the second surface 41b is connected to a first end 441 of the transmission shaft 44.

The temperature control sheet 41 further has a pair of large adjusting holes and a pair of small adjusting holes respectively formed by a first large tapered hole 411 and a second large tapered hole 412 and by a first small tapered hole 413 and a second small tapered hole 414. The large tapered holes and the small tapered holes are alternately disposed. A small area portion of the first large tapered hole 411 is adjacent to a small area portion of the first small tapered hole 413. A large area portion of the first large tapered hole 411 is adjacent to a small area portion of the second small tapered hole 414. A small area portion of the second large tapered hole 412 is adjacent to a large area portion of the first small tapered hole 413. A large area portion of the second large tapered hole 412 is adjacent to a large area portion of the second small tapered hole 414.

The first water seal 42 and the second water seal 43 of this embodiment are respectively pressed against the first large tapered hole 411 and the second large tapered hole 412 or against the first small tapered hole 413 and the second small tapered hole 414. In the mode of discharging warm water out of a single water tap, the required water outlet quantity (water pressure) does not need to be too large. Therefore, the first water seal 42 and the second water seal 43 are pressed against the first small tapered hole 413 and the second small tapered hole 414, such that the hot water and the cold water flow through the first small tapered hole 413 and the second small tapered hole 414. In the mode of discharging warm water simultaneously out of multiple water taps, the required water outlet quantity (water pressure) must be large. Therefore, the first water seal 42 and the second water seal 43 are pressed against the first large tapered hole 411 and the second large tapered hole 412, such that the hot water and the cold water flow through the first large tapered hole 411 and the second large tapered hole 412. Through the above structure, a two-stage water temperature control of a large water quantity (the mode of discharging water out of multiple water taps) and a water-saving quantity (the mode of discharging water out of a single water tap) can be performed on the same temperature control sheet 41.

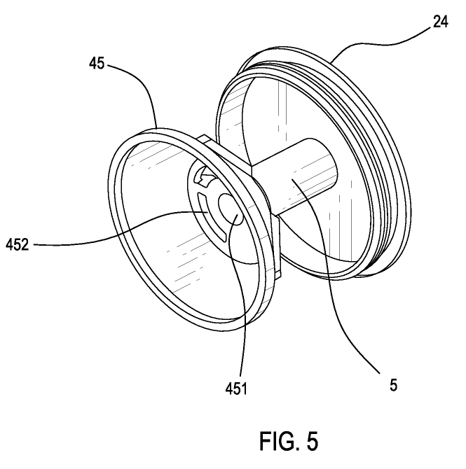

FIG. 5 is a schematic structural view of the water mixer according to the embodiment of the present invention. Referring to FIGS. 1 and 2 together, the water mixer of this embodiment is connected to the upper cover 24 through a hollow cylinder 5, and the upper cover 24, the hollow cylinder 5, and the water mixer 45 are integrally formed. Besides, the water mixer 45 may be fixedly disposed to omit the structure of the hollow cylinder 5 (not shown), but the present invention is not limited thereto.

The water mixer 45 of a tapered funnel structure has a large opening portion pressed against the temperature control sheet 41 and a small opening portion connected to the hollow cylinder 5. The small opening portion has a through-hole 451 and a number of water outlets 452. The through-hole 451 is communicated with the hollow cylinder 5 for the transmission shaft 44 to pass through. A second end 442 of the transmission shaft 44 is connected to a driving source. The driving source of the present invention is, but not limited to, a stepping motor 6.

If a total area of the water outlets 452 located at the small opening portion is too small, the water outlet pressure is diminished and is disadvantageous for the water discharge from multiple water taps. If the total area is too large, though the water outlet pressure is large, the mixing effect is undesired. Therefore, preferably, the total area of the water outlets 452 is 1.1 to 1.2 times larger than that of the water inlets of the two water seals 42 and 43.

Additionally, in order to optimize the mixing effect, an inner side wall of the water mixer 45 and the temperature control sheet 41 form a taper angle θ (as shown in FIG. 2) of 42±1°, so as to achieve an optimal mixing effect of the present invention.

When the hot water flow enters the large opening portion of the water mixer 45 through the first water seal 42 and the first large tapered hole 411 or the first small tapered hole 413 of the temperature control sheet 41, and meanwhile the cold water flow enters the large opening portion of the water mixer 45 through the second water seal 43 and the second large tapered hole 412 or the second small tapered hole 414 of the temperature control sheet 41, the hot water flow and the cold water flow are mixed in a helical direction along the inner wall of the water mixer 45 due to the tapered funnel structure of the water mixer 45, so as to accelerate the mixing, and the warm water obtained after mixing flows out of the water outlets 452 towards the outlet passage 23. As the mixing of the hot water flow and the cold water flow is performed in a helical direction on the inner wall of the water mixer 45, a mixing time-distance path is expanded, and the height of the entire water mixer 45 can be reduced to achieve an optimized stable mixing effect within a short distance.

A microcomputer control module (not shown) is electrically connected to the stepping motor 6 and a temperature sensor. After the user inputs a required temperature to the microcomputer control module through a digital control interface, the microcomputer control module controls the stepping motor 6 to rotate the temperature control sheet 41 so as to control the positions of the two water seals relative to the two large tapered holes or the two small tapered holes, thereby controlling the flow quantities of the hot water and the cold water. After the hot water flow and the cold water flow are mixed in the water mixer 45, a warm water flow is obtained and passes through the outlet passage 23. When the warm water flow obtained after mixing passes through the temperature sensor, the temperature sensor senses the temperature of the warm water and transmits an information to the microcomputer control module, so as to determine whether the outlet water temperature is required by the user. In this manner, a digital control is achieved.

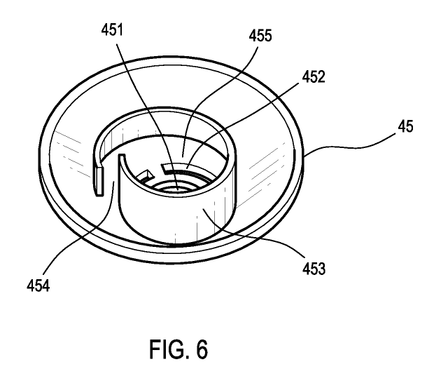

FIG. 6 is a schematic structural view of a temperature control sheet according to another embodiment of the present invention. A helical guide rib 453 is disposed on the inner wall of the water mixer 45. The guide rib 453 has an inlet portion 454 and an outlet portion 455. The inlet portion 454 is adjacent to the temperature control sheet 41. The outlet portion 455 is communicated with the outlet holes 452. The water mixer 45 is rotatably connected to the upper cover 24 by the hollow cylinder 5. Preferably, the water mixer 45 is connected to the hollow cylinder 5 through a C-shaped ring (not shown).

Therefore, when the hot water flow enters the large opening portion of the water mixer 45 through the first water seal 42 and the first large tapered hole 411 or the first small tapered hole 413 of the temperature control sheet 41, and meanwhile the cold water flow enters the large opening portion of the water mixer 45 through the second water seal 43 and the second large tapered hole 412 or the second small tapered hole 414 of the temperature control sheet 41, the hot water flow and the cold water flow simultaneously pass through the inlet portion 454, and are mixed in a helical direction under the guidance of the guide rib 453. The mixing can be accelerated if the water mixer 45 rotates freely. Afterward, a warm water flow obtained after mixing flows out of the water outlets 452 through the outlet portion 455 and towards the outlet passage 23. As the mixing of the hot water flow and the cold water flow is performed on the inner wall of the water mixer 45 in a helical direction, a mixing time-distance path is expanded, and the height of the entire water mixer 45 can be reduced to achieve an optimized stable mixing effect within a short distance.

The above descriptions are only illustrative, but not intended to limit the present invention. Various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A water flow temperature control system, comprising:
a valve, having a first inlet passage, a second inlet passage, an outlet passage, and an upper cover;
a pressure equalization valve, disposed in the valve, for controlling the quantity of a water flow flowing through the first inlet passage and the quantity of a water flow flowing through the second inlet passage, wherein the pressure equalization valve has a first chamber and a second chamber respectively disposed corresponding to the first inlet passage and the second inlet passage; and
a mixing device, having a temperature control sheet, a first water seal, a second water seal, a transmission shaft, and a water mixer, wherein the first water seal and the second water seal are pressed between the pressure equalization valve and the temperature control sheet and are disposed corresponding to the first chamber and the second chamber, the temperature control sheet has a number of adjusting holes disposed corresponding to the positions of the first water seal and the second water seal, the water mixer of a tapered funnel structure is disposed between the upper cover and the temperature control sheet and has a large opening portion and a small opening portion, the large opening portion is adjacent to the temperature control sheet and the small opening portion having a through-hole in the center and a number of water outlets is adjacent to the upper cover, a first end of the transmission shaft is connected to the temperature control sheet, and a second end of the transmission shaft is connected to a stepping motor through the through-hole and the upper cover so as to control the rotation of the temperature control sheet through the stepping motor.

2. The water flow temperature control system according to claim 1, wherein the adjusting holes of the temperature control sheet comprise a first large tapered hole, a second large tapered hole, a first small tapered hole, and a second small tapered hole, each tapered hole has a large area portion and a small area portion, the small area portion of the first large tapered hole is adjacent to the small area portion of the first small tapered hole, the large area portion of the first large tapered hole is adjacent to the small area portion of the second small tapered hole, the small area portion of the second large tapered hole is adjacent to the large area portion of the first small tapered hole, and the large area portion of the second large tapered hole is adjacent to the large area portion of the second small tapered hole.

3. The water flow temperature control system according to claim 1, wherein the water mixer is further provided with a helical guide rib, the guide rib has an inlet portion and an outlet portion, the inlet portion is adjacent to the large opening portion, and the outlet portion is adjacent to the small opening portion and connected to the water outlets.

4. The water flow temperature control system according to claim 1, wherein a total area of the water outlets is 1.1 to 1.2 times larger than that of the water inlets of the water seals.

5. The water flow temperature control system according to claim 1, wherein the water mixer has a taper angle of 42±1° defined between an inner side wall of the water mixer and the temperature control sheet.

6. The water flow temperature control system according to claim 1, wherein the water mixer is rotatably connected to the upper cover by a hollow cylinder to form an integral structure, the through-hole of the water mixer is communicated with the hollow cylinder, and a second end of the transmission shaft passes through the through-hole, the hollow cylinder, and the upper cover.

7. The water flow temperature control system according to claim 2, wherein the outlet passage is further provided with a temperature sensor for sensing the outlet water temperature.

8. The water flow temperature control system according to claim 7, wherein the stepping motor and the temperature sensor are electrically connected to a microcomputer control module, after a user inputs a required temperature to the microcomputer control module through a digital control interface, the microcomputer control module controls the stepping motor to rotate the temperature control sheet so as to control the positions of the two water seals relative to the two large tapered holes or the two small tapered holes, thereby controlling the quantities of a hot water flow flowing in from the first inlet passage and a cold water flow flowing in from the second inlet passage, after the hot water flow and the cold water flow are mixed in the water mixer, a warm water flow is obtained and passes through the outlet passage, and when the warm water flow passes through the temperature sensor, the temperature sensor senses a temperature of the warm water flow and transmits an information to the microcomputer control module, so as to determine whether the outlet water temperature is required by the user.

9. A water flow temperature control system, comprising:
a valve, having a first inlet passage, a second inlet passage, and an outlet passage;
a pressure equalization valve, disposed in the valve for controlling the quantity of a water flow flowing through the first inlet passage and the quantity of a water flow flowing through the second inlet passage, wherein the pressure equalization valve has a first chamber and a second chamber respectively disposed corresponding to the first inlet passage and the second inlet passage;
a mixing device, disposed between the two inlet passages and the outlet passage of the valve, and having a water mixer and a temperature control sheet, wherein the temperature control sheet has a pair of penetrating large adjusting holes and a pair of penetrating small adjusting holes, and a cross-sectional area of the pair of large adjusting holes is larger than that of the pair of small adjusting holes;
a driving source, for driving the mixing sheet to move rotatably; and
a microcomputer control module, for controlling the driving source to adjust a moving position of the temperature control sheet and selectively communicate the pair of first adjusting holes or the pair of second adjusting holes with the two inlet passages and the outlet passage.

10. The water flow temperature control system according to claim 9, wherein the pair of large adjusting holes are formed by a first large tapered hole and a second large tapered hole, the pair of small adjusting holes are formed by a first small tapered hole and a second small tapered hole, each tapered hole has a large area portion and a small area portion, the small area portion of the first large tapered hole is adjacent to the small area portion of the first small tapered hole, the large area portion of the first large tapered hole is adjacent to the small area portion of the second small tapered hole, the small area portion of the second large tapered hole is adjacent to the large area portion of the first small tapered hole, and the large area portion of the second large tapered hole is adjacent to the large area portion of the second small tapered hole.

11. The water flow temperature control system according to claim 9, wherein the mixing device further has a first water seal, a second water seal, a transmission shaft, and a water mixer, the first water seal and the second water seal are pressed between the pressure equalization valve and the temperature control sheet and are disposed corresponding to the first chamber and the second chamber, the adjusting holes of the temperature control sheet are respectively disposed corresponding to the positions of the first water seal and the second water seal, the water mixer of a tapered funnel structure is disposed between the upper cover and the temperature control sheet and has a large opening portion and a small opening portion, the large opening portion is adjacent to the temperature control sheet and the small opening portion having a through-hole in the center and a number of water outlets is adjacent to the upper cover, a first end of the transmission shaft is connected to the temperature control sheet, and a second end of the transmission shaft is connected to the driving source via the through-hole and the upper cover so as to control the rotation of the temperature control sheet through the driving source.

12. The water flow temperature control system according to claim 11, wherein the water mixer is further provided with a helical guide rib, the guide rib has an inlet portion and an outlet portion, the inlet portion is adjacent to the large opening portion, and the outlet portion is adjacent to the small opening portion and connected to the water outlets.

13. The water flow temperature control system according to claim 11, wherein a total area of the water outlets is 1.1 to 1.2 times larger than that of the water inlets of the water seals.

14. The water flow temperature control system according to claim 11, wherein the water mixer has a taper angle of 42±1° defined between an inner side wall of the water mixer and the temperature control sheet.

15. The water flow temperature control system according to claim 9, wherein the outlet passage is further provided with a temperature sensor for sensing the outlet water temperature.

16. The water flow temperature control system according to claim 15, wherein the driving source and the temperature sensor are electrically connected to the microcomputer control module, after a user inputs a required temperature to the microcomputer control module through a digital control interface, the microcomputer control module controls the driving source to rotate the temperature control sheet so as to control the positions of the two water seals relative to the two large tapered holes or the two small tapered holes, thereby controlling the quantities of a hot water flow flowing in from the first inlet passage and a cold water flow flowing in from the second inlet passage, after the hot water flow and the cold water flow are mixed in the water mixer, a warm water flow is obtained and passes through the outlet passage, and when the warm water flow passes through the temperature sensor, the temperature sensor senses a temperature of the warm water flow and transmits an information to the microcomputer control module, so as to determine whether the outlet water temperature is required by the user.

17. The water flow temperature control system according to claim 9, wherein the driving source is a stepping motor.

18. The water flow temperature control system according to claim 11, wherein the water mixer is rotatably connected to the upper cover by a hollow cylinder to form an integral structure, the through-hole of the water mixer is communicated with the hollow cylinder, and a second end of the transmission shaft passes through the through-hole, the hollow cylinder, and the upper cover.
